(19) United States
(12) Patent Application Publication
(10) Pub. No.: US 2004/0133733 A1
(43) Pub. Date: Jul. 8, 2004

(54) Storing, retrieving and displaying captured data in a network analysis system

(75) Inventors: Timothy E. Bean, Pleasanton, CA (US); Gary Carter, Morgan Hill, CA (US); Cuong Tran, San Jose, CA (US); Scott Pelger, San Jose, CA (US)

Correspondence Address: ERIC L. MASCHOFF, WORMAN NYDEGGER, 1000 Eagle Gate Tower, 60 East South Temple, Salt Lake City, UT, 84111, US

(73) Assignee: Finisar Corporation

(21) Appl. No.: 10/703,167

(22) Filed: Nov. 6, 2003

Related U.S. Application Data
(60) Provisional application No. 60/424,500, filed on Nov. 6, 2002.

(51) Int. Cl. G06F 12/00

(52) U.S. Cl. 711/100

(57) ABSTRACT

Analyzing data on a network. A method of analyzing data on a network is disclosed. The method includes capturing network traffic on the network during a period of time where the network traffic is captured as raw data into data blocks. The data blocks are streamed to a mass storage. The data blocks are organized into logical blocks on the mass storage. A set of data points are compiled. The data points are useful for defining information about the logical blocks. The data points include an offset defining a number of bytes into the captured data and datum headers including the number of frames into a logical block, number of bytes contained in the logical block and clock ticks since the initiation of capturing.

### CROSS REFERENCE TO RELATED APPLICATIONS

This application claims the benefit of U.S. Provisional Application No. 60/424,500, filed Nov. 6, 2002, which is incorporated herein by this reference.

### BACKGROUND OF THE INVENTION

1. The Field of the Invention

The invention generally relates to the field of analyzing network data. More specifically the invention relates to systems and methods for storing captures to reduce the amount of data that needs to be processed to view network data captured over a specified time period.

2. Description of the Related Art

Modem computer networks involve the transmission of large amounts of data at very high speeds across the networks. For example, in some networks, transmission rates as high as 10 Gbits/second are currently being used. Today, hardware and protocols that will support transmission rates up to 40 Gbits/second are being developed. Within these networks, transmission problems may occur intermittently.

Using network analysis tools, network administrators can identify and resolve various types of network problems. In some situations, network problems may be resolved by sampling a portion of the data transmitted across the network or by performing a statistical analysis on portions of the transmitted data. Other solutions require the collection of all data that traverses the network during a given time period.

Collecting all of the data into a capture enables a network administrator to perform a detailed analysis on the collected data. However, recording network traffic that travels at such high transmission rates may result in very large captures. In fact, the resources used to process and view captures may be inadequate. For example, a 10 Gbits/second network can generate a 60 Gigabyte (GB) file in less than a minute. To perform a detailed analysis of the network data in a 60 GB capture, the 60 GB capture must be opened and analyzed on the network administrator's computer. Directly opening such a large file using a typical computer can take hours due to the data processing required to make the network data presentable to the network administrator. Additionally, such large captures require significant memory resources, the use of which can be burdensome to a computer system.

Prior attempts to reduce the processing requirements of captures include using filtering algorithms such that only data meeting a specified filter criteria is displayed to the network administrator. Generally, such filters are provided after the data has been captured, meaning that data is initially captured, then filtered. As a result, processing the capture by applying a filter may reduce the processing requirements, but can still take a lot of time. Additionally, the network administrator may not know exactly what to filter, making this a hit or miss solution. Another challenge arises when a network administrator in one location needs to troubleshoot data collected in another location, because the analysis of high-speed networks typically requires the processing of large amounts of captured data, which cannot be easily transmitted to remote locations.

### BRIEF SUMMARY OF THE INVENTION

One embodiment of the invention includes a method of storing data from a network. The method includes capturing network traffic during a period of time such that the network traffic is captured as raw data into data blocks. The data blocks are streamed to a mass storage. The data blocks are organized into logical blocks on the mass storage. Data points are compiled. The data points are useful for defining information about the logical blocks. The data points include an offset defining a number of bytes in the captured data, and datum headers including the number of frames in a logical block, the number of bytes in a logical block and clock ticks since the initiation of capturing. Advantageously, the data points represent a summary of the network traffic that can be transported and displayed to a computer user easier than the entire set of network traffic.

Another embodiment of the invention includes a method of analyzing network traffic. The network traffic is data captured on a network during a period of time. The network traffic is captured as raw data into logical blocks on a mass storage. A number of data points are compiled. The data points are useful for defining information about the logical blocks. The data points include an offset that defines a number of bytes into the captured data. The data points also include datum headers that include the number of frames in a logical block, the number of bytes contained in the frames, and clock ticks since the initiation of capturing network traffic. The method includes presenting a user with a graphical user interface representation of the network traffic by graphing the data points to show byte density over time in a capture histogram. In this way, the amount of information that needs to be sent to a user to summarize the network traffic can be reduced.

Another embodiment of the invention includes a computer readable medium having a number of data fields stored on the medium and representing a data structure. The computer readable medium includes a captured data storage field containing data stored in logical blocks. The data represents data frames captured during a capture operation. The computer readable medium further includes a histogram data storage field containing data representing a compilation of data points. The data points include an offset defining the number of bytes into the data frames captured during the capture operation. The data points further include datum headers including the number of frames in a logical block, number of bytes in a logical block, and click ticks since the initiation of capturing. Such a structure allows for a reduction in computing resources for presenting a summary of the data frames captured during a capture operation. Further, such a structure allows for a reduction in the amount of data that must be transmitted to a user for viewing a summary of the data frames captured during the capture operation.

These and other advantages and features of the present invention will become more fully apparent from the following description and appended claims, or may be learned by the practice of the invention as set forth.

### BRIEF DESCRIPTION OF THE DRAWINGS

In order that the manner in which the advantages and features of the invention are obtained, a more particular description of the invention will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a typical network topology on which the invention may be deployed;

FIG. 2 illustrates the organization of one embodiment of a capture; and

FIG. 3 illustrates one embodiment of a graphical user interface displaying graphically a description of the contents of a capture.

### DETAILED DESCRIPTION OF THE INVENTION

In order to resolve problems that may exist on a network, it is often necessary to analyze the network data traffic. This is achieved by storing network data in captures. As previously described, however, captures can become large in short periods of time because of data transmission rates. As a result, users, which may include network administrators may have to store, retrieve, process, and view large amounts of data. Embodiments of the present invention relate to systems and methods for storing, retrieving, and displaying data including captures. Advantageously, embodiments of the present invention can reduce the amount of data that is processed, thereby improving the ability to resolve network problems.

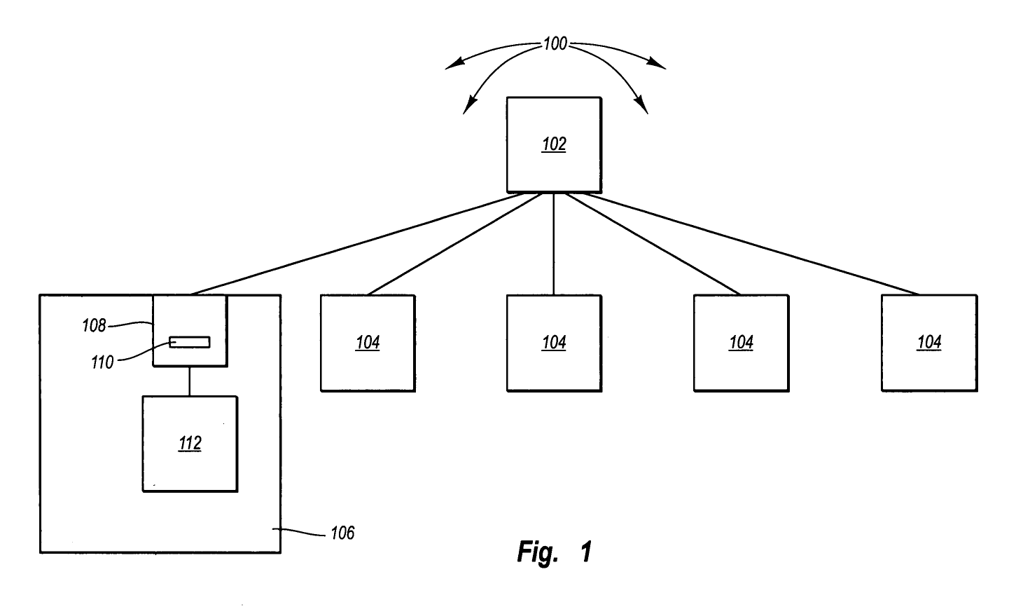

Referring now to FIG. 1, a general overview of the data capture operation of one embodiment of the invention is shown. FIG. 1 shows one network topology 100 on which the present invention may be used although one of skill in the art can appreciate that a network may include, but is not limited to, Local Area Networks, Wide Area Networks, the Internet, and the like or any combination thereof. The network topology 100 may also be either a wired and/or wireless network. In this example, a network switch or router 102 controls the flow of network data to client computers 104. A network monitoring computer 106 is used by the network administrator to detect and solve transmission problems existing on the network. The network monitoring computer 106 has a capture device 108 that captures and processes or analyzes all of the network traffic during, for example, selected periods of time.

To initiate the analysis process and to troubleshoot transmission problems existing on the network, the network monitoring computer 106 performs a capture operation to collect data on the network. During the capture operation, data is streamed from the interface (e.g. a network adapter card) of the capture device 108 to a memory buffer 110 on the capture device 108. The data is captured as raw data into data blocks. The sizes of the captured data blocks do not necessarily correspond to packet size. In this embodiment, each of the packets in the data blocks is marked with a counter value, indicating the number of clock ticks since the capture was started.

When data is collected, the data blocks are often streamed from the memory buffer 110 on the capture device 108 to a disk or other mass storage 112 that is external with respect to the capture device 108 and has more storage capacity. The process of physically storing the data to the mass storage 112 is governed by the technology of the software and hardware provided by the disk manufacturer. For example, the data is often stored in 512-byte sectors on the mass storage 112.

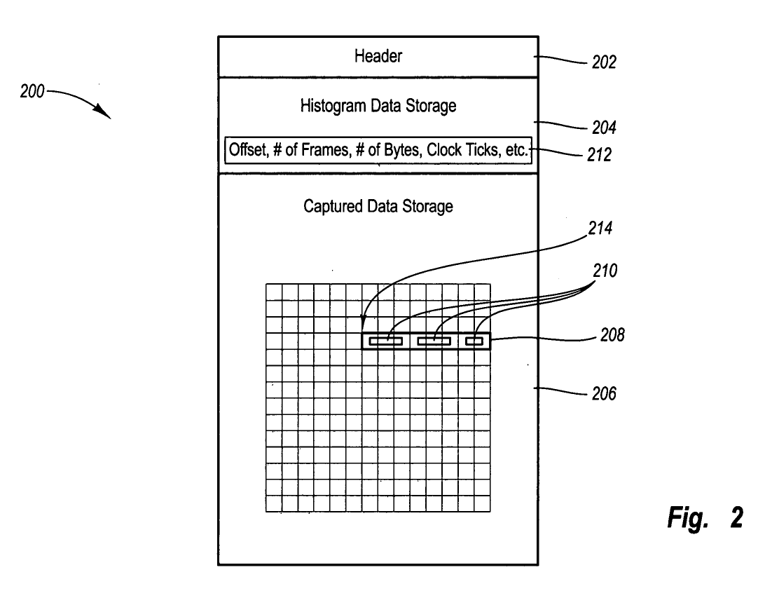

In one embodiment, the network administrator is able to retrieve and analyze the captured data in an order that can be determined by the network administrator. In other words, the network administrator is not limited to retrieving the captured data in a sequential manner. This is achieved, in one embodiment, by organizing the captured raw data into logical blocks that are referred to herein and shown in FIG. 2 as datums 208. In one embodiment, each logical block corresponds to a datum 208. A datum 208 may include one or more physical sectors on the mass storage 112 or storage device on which the datum 208 is stored and may contain one or more frames 210 of data from the network. Each datum 208 has a corresponding datum header that describes information concerning the datum 208. The information described in a particular datum header may include the number of frames (or packets) captured in the corresponding datum 208, the number of bytes contained in the frames 210 and a count of the clock ticks since the initiation of the capture operation in which the data in the particular datum 208 was captured.

During the capture operation, a set of data points 212 are stored at various offsets or numbers of bytes into the captured data. A data point 212 includes an offset of the first frame of a datum in the mass storage 112 and the datum header information corresponding to the data point 212. This information is recorded as part of a capture such as the capture shown in FIG. 2 and designated generally as 200. The offset of each data point is recorded to create a compilation of the datum header records as the raw data is written to the mass storage 112. Once the capture operation is complete and the raw data is written to the mass storage 112, the data points and each of their respective datum headers are also written to the histogram data storage area 204 of the new capture 200.

According to one embodiment of the invention, the newly created capture stored on disk is logically divided into three parts, including a capture header 202, the aforementioned histogram data storage 204 and captured data storage 206. The capture header 202 contains information related to the entire capture. This information may include a magic or parity string used to verify the validity of the data on the mass storage 112, the capture device 108 speed when the capture occurs, the starting time and stopping time of the capture, the number of frames captured to memory buffer 110 on the capture device 108, the number of frames stored from memory buffer 110 onto the mass storage 112, whether the captured data is sliced or truncated, and the length of the slice or truncation of the data, if applicable.

The histogram data storage 204 may contain the offset and datum header for each datum in the captured data. Captured data storage 206 contains the captured data frames 210 in the form of raw data. Each frame 210 may have a packet header, packet data and optional padding. The capture 200 continues to fill with raw data until the mass storage 112 is full or the network administrator stops the capture process.

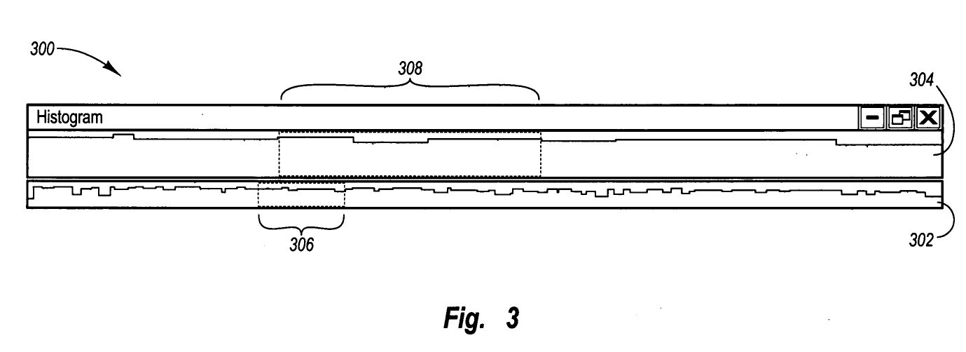

From the capture header 202 information and histogram data storage 204, a graphical user interface (GUI) representation of the capture data can be generated by graphing byte density over time in a histogram, such as is shown in FIG. 3 by the GUI designated generally as 300. The information needed to display the graph of GUI 300 is smaller than the full volume of the captured data. Thus, the information associated with GUI 300 can be transmitted to a computer used by the network administrator in a short amount of time, whether the network administrator is located locally or remotely with respect to the capture device 108 or the mass storage 112. The GUI 300 presents a summarized view of parameters or characteristics of the captured data and enables the network administrator to make an informed decision. The GUI 300, for example, helps identify a subset, or segment, of the captured data that is to be processed and displayed in more detail, as described in greater detail below.

To enable the network administrator to select a capture segment of the captured data for further analysis, the GUI presents a histogram to a network administrator as described above. In this example, a portion of the histogram is represented in a data selection window 308 of FIG. 3, which highlights a segment of the histogram that graphically represents selected parameters or characteristics of the captured data. The operation of data selection window 308 and its relationship with other portions of GUI will be described in greater detail below. The width of the data selection window 308 can be adjusted to increase or reduce the size of the capture segment selected by the network administrator. When a capture segment is selected in the histogram, the selected capture segment coordinates defined by the corresponding highlighted segment of the histogram are translated into beginning and end location addresses in the capture data storage 206 section of the capture 200 on mass storage 112 or another storage device using the data points in the histogram data storage area 204 of the capture 200. An analysis engine associated with the capture device 108 then formats only the raw data from the beginning location address to the end location address for display and calculates packet timestamp values from the stored clock tick counts.

In this manner, network administrators can navigate through large amounts,of captured data without processing the full volume of captured data and/or transmit the full volume of captured data from the capture device to a computer that is used to display analysis information to the network administrator. As shown in FIG. 3, the initial data transmitted to the computer associated with the network administrator is represented graphically by two interdependent graphs or histograms. The capture histogram 302 represents the entire captured data set. Within this capture histogram 302 is a zoom window 306 that the network administrator can drag for navigation to highlight a segment of the capture histogram. The width of the zoom window 306 in the capture histogram 302 is defined to encapsulate a subset, such as 10 percent, of the bytes of the entire volume of captured data. For example, if there are 256 GB of captured data, the zoom window 306 on the capture histogram 302, in this example, represents 25.6 GB of data. Once the zoom window 306 is positioned and released in the capture histogram 302, a zoom histogram 304 graphically represents the span of data highlighted and defined by the zoom window 306 in the capture histogram 302.

A capture viewer is a control used to display the actual packets that are selected using the selection window 308. After the segment is selected using the capture histogram as described above, the corresponding packets are obtained, decoded and displayed using the capture viewer. The network administrator can move or dock the GUI 300, with its histograms, to any location on the screen or hide them altogether. FIG. 3 shows an undocked zooming histogram 304 and capture histogram 302. Each histogram in this example is arranged with time along the horizontal axis and bytes along the vertical axis. The zoom histogram 304 is a slave to the capture histogram 302. The zoom histogram 304 serves for fine-tune navigation and additional zooming functionality. The width of the data selection window 308 on the zoom histogram 304 is not predefined, but is user configurable. The width may be determined to be equal to a number of bytes as defined by the network administrator.

The zoom histogram 304 has the ability to zoom out using a computer mouse via a Ctrl+left-double-click and a zoom-in via a left-double-click action or by any other suitable user input mechanism. The amount of zoom is user defined with a default of 80 percent. For example, with an 80 percent zoom, a left-double-click in the zoom histogram window causes the middle 80 percent of the previous data to remain with 10 percent shaved off either end. A click-drag-release operation allows the network administrator to manually fine tune the data selection window 308 by selecting an edge and dragging it, thereby increasing or decreasing the size of the data selection window 308 dynamically.

Accordingly, the network administrator is able to select portions of a capture such that only the portions that the network administrator desires to view are processed. Such a method and apparatus reduces the amount of resources needed to effectively view a file for troubleshooting network problems. This is useful when the volume of captured data is large enough that processing of all of the data would require excessive amounts of time or excessive computing resources. Moreover, when the capture device 108 is connected with the computer associated with the network administrator using a network link having a relatively low bandwidth the use of the invention to select a subset of the capture data for processing and transmission can greatly increase the ability to perform troubleshooting and analysis of network data and traffic. This is particularly beneficial in situations in which the network administrator is at a site that is remote with respect to the capture device 108, since significantly less than the full volume of captured data needs to be transmitted from the capture device to the remote site.

Aspects of the present invention may be embodied in several forms. For instance, some aspects of the invention may be embodied using a digital computer such as those that are ubiquitously present. The digital computer may store software code useful for executing acts specified in embodiments of the invention. The digital computer may also embody certain aspects of systems in which manifestations of the invention are present. Further, aspects of the invention may be embodied in the form of a computer readable medium with instructions for performing acts specified in embodiments of the invention. Illustratively, but not exhaustively, such computer readable medium may be floppy disks, CD or DVD media, tape drives, computer hard drives and the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of storing data from a network for use in network analysis, the method comprising:
capturing network traffic on a network during a period of time, wherein the network traffic is captured as raw data;
organizing the raw data into logical blocks on a mass storage; and
compiling data points, each data point defining information about one of the logical blocks, each data point including:
an offset defining a number of bytes into the captured network traffic; and
datum headers including a number of frames in a logical block, number of bytes contained in the logical block, and clock ticks since the initiation of capturing.

2. The method of claim 1, the offset of a particular data point defining the first byte of a logical block associated with the particular data point.

3. The method of claim 1, further comprising writing the logical blocks to the mass storage in a captured data storage portion of a capture.

4. The method of claim 3, further comprising writing the compiled data points to the mass storage in a histogram data storage portion of the capture after the act of capturing has been completed.

5. The method of claim 4, further comprising writing a capture header portion of the capture to the mass storage, the capture header including at least one of:
a parity string used to verify the validity of the raw data;
speed at which capturing network traffic occurs;
start and stop times when capturing network traffic occurs;
number of frames captured; and
whether the captured network traffic is sliced or truncated and the length of a slice or truncation.

6. A method of analyzing network traffic, the network traffic being captured data on a network during a period of time, the method comprising:
accessing a plurality of data points corresponding to logical blocks of the network traffic, the data points comprising:
an offset defining a number of bytes into the captured data;
a number of frames in a logical block;
a number of bytes contained in the logical block; and
a number of clock ticks since the initiation of capturing; and
presenting a user with a graphical user interface representation of the network traffic, by graphing the data points to show byte density over time in a capture histogram.

7. The method of claim 6, wherein presenting is accomplished by presenting the graphical user interface to a user that is remote from the mass storage.

8. The method of claim 6, wherein presenting a user with a graphical user interface representation of the network traffic comprises:
including a zoom window, the zoom window useful for highlighting a segment of the capture histogram; and
representing the segment of the capture histogram in a zoom histogram.

9. The method of claim 8, further comprising:
including a data selection window useful for highlighting a segment of the zoom histogram; and
displaying data frames corresponding to the highlighted segment of the zoom histogram.

10. The method of claim 9, further comprising:
formatting the raw data that is necessary for displaying the data packets corresponding to the highlighted segments of the zoom histogram; and
calculating packet timestamp values from the clock ticks for displaying the packet timestamp values with the formatted raw data.

11. A computer readable medium with instructions for performing the method of claim 10.

12. A computer readable medium having a plurality of data fields stored on the medium and representing a data structure, comprising:
a captured data storage field containing data stored in logical blocks representing data frames captured during a capture operation; and
a histogram data storage field containing data representing a compilation of data points, each data point comprising:
an offset defining a number of bytes into the data frames captured during the capture operation; and
datum headers including a number frames in a logical block, number of bytes contained in the frames, and clock ticks since the initiation of capturing.

13. The computer readable medium of claim 12, further comprising a capture header.

14. The computer readable medium of claim 13, the capture header including at least one of:
a parity string used to verify the validity of raw data;
speed at which the capture operation occurred;
start and stop times when the capture operation occurred;
number of frames captured in the capture operation; and
whether the data captured in the capture operation is sliced or truncated and the length of the slice or truncation.

15. The computer readable medium of claim 12, the offset defining a first byte of the logical block.

16. In a computer system having a graphical user interface, a method of displaying captured network traffic, the method comprising:
retrieving data points from at least a portion of a capture, the data points comprising:
an offset defining a number of bytes into captured raw data of the captured network traffic, the raw data organized into logical blocks or datums; and
datum headers including the number of frames in a logical block, number of bytes contained in the logical block, and clock ticks since the initiation of capturing.
presenting a user with a graphical user interface representation in the form of a histogram of the network traffic using the data points by graphing byte density over time.

17. The method of claim 16, further comprising:
the user computer configured to allow a user to select of a portion of the histogram; and
displaying data frames corresponding to the selected portion of the histogram.

18. The method of claim 16, further comprising formatting the raw data for display including calculating packet timestamp values.

19. The method of claim 16, wherein presenting a user with a graphical user interface representation in the form of a histogram of the network traffic using the data points by graphing byte density over time comprises:
presenting a capture histogram that represents all of the captured network traffic;
rendering a zoom window within the capture histogram;
presenting a zoom histogram from the zoom window in the capture histogram,
receiving input whereby a user selects a portion of the zoom histogram; and
displaying the data represented by the selected portion of the zoom histogram.

20. The method of claim 19, wherein the zoom histogram is a slave to the capture histogram.

21. The method of claim 19, further comprising: presenting a data selection window in the zoom histogram;
receiving a user selection of a portion of the histogram with the data selection window; and
displaying data frames corresponding to the selected portion of the histogram.
